(19) United States
(12) Patent Application Publication
(10) Pub. No.: US 2011/0249536 A1
(43) Pub. Date: Oct. 13, 2011

(54) Chronograph timepiece

(76) Inventors: Kenji Ogasawara, Chiba-shi (JP); Akira Takakura, Chiba-shi (JP); Saburo Manaka, Chiba-shi (JP); Keishi Honmura, Chiba-shi (JP); Takanori Hasegawa, Chiba-shi (JP); Kosuke Yamamoto, Chiba-shi (JP); Kazumi Sakumoto, Chiba-shi (JP); Hiroshi Shimizu, Chiba-shi (JP); Kazuo Kato, Chiba-shi (JP); Eriko Noguchi, Chiba-shi (JP); Tomohiro Ihashi, Chiba-shi (JP)

(21) Appl. No.: 12/930,369

(22) Filed: Jan. 5, 2011

(30) Foreign Application Priority Data
Jan. 6, 2010 (JP) 2010-001552

(51) Int. Cl. G04F 10/00

(52) U.S. Cl. 368/112

(57) ABSTRACT

For a chronograph timepiece that chronograph hands are mechanically reset to zero and electrically driven, the chronograph hands are prevented from being electrically driven while being mechanically locked. A chronograph timepiece that is mechanically reset to zero includes a chronograph motor for driving a chronograph hand, a drive unit configured to drive the chronograph motor according a time measurement operation in response to a starting operation by an operating section, and a control unit configured to control the drive unit. The control unit has a rotation detecting circuit for detecting a rotation status of the chronograph motor. When the rotation detecting circuit detects that the chronograph motor is not rotated after the chronograph motor has been rotated a predetermined time period, driving the chronograph motor by the drive unit is stopped for resetting the time measurement operation.

### BACKGROUND OF THE INVENTION

1. Field of the Invention

The present invention relates to a chronograph timepiece having functions of indicating a time of day and measuring a time period.

2. Description of the Related Art

Conventionally, for chronograph timepieces mounted with a plurality of drive motors for individually driving a plurality of hands and further mounted with additional functions (chronograph functions) of measuring a time period in addition to a basic function of indicating information about a time of day, such chronograph timepieces are developed that the above-mentioned drive motors electrically drive the individual hands and mechanical devices such as a heart cam reset chronograph hands to zero. For example, see JP-A-61-73085 (Patent Document 1), JP-A-2006-90769 (Patent Document 2), and JP-A-2003-4872 (Patent Document 3).

In the conventional chronograph timepieces that are mechanically reset to zero and electrically driven, generally, a start button is operated to clear a zero reset mechanism as well as the start button is operated to input electrical chronograph start signals for driving chronograph hand drive motors.

However, there is a problem in that when an electrical noise signal equivalent to the chronograph start signal is inputted because of noise or the like, drive pulses are continuously fed to the chronograph hand drive motors for consuming a battery used for a power supply.

### SUMMARY OF THE INVENTION

It is an aspect of the present application to prevent chronograph hands from being electrically driven while the chronograph hands are mechanically locked, in a chronograph timepiece that the chronograph hands are mechanically reset to zero and electrically driven.

According to the application, provided is a chronograph timepiece that is mechanically reset to zero. The chronograph timepiece includes a chronograph motor configured to drive a chronograph hand, a drive unit configured to drive the chronograph motor according to a time measurement operation in response to a starting operation by an operating section, and a control unit configured to control the drive unit. The control unit includes a rotation detecting section configured to detect a rotation status of the chronograph motor. When the rotation detecting section detects that the chronograph motor is not rotated after the chronograph motor has been driven for a predetermined time period, driving the chronograph motor by the drive unit is stopped for resetting the time measurement operation.

According to the chronograph timepiece of the application, for a chronograph timepiece that chronograph hands are mechanically reset to zero and electrically driven, it is made possible to prevent such an event that the chronograph hands are electrically driven while being mechanically locked. Consequently, it is made possible to eliminate unnecessary power consumption.

### BRIEF DESCRIPTION OF THE DRAWINGS

FIG. 1 shows a block diagram depicting a chronograph timepiece according to an embodiment of the invention;

FIG. 2 shows a detailed circuit diagram partially depicting the chronograph timepiece according to this embodiment of the invention;

FIG. 3 shows an illustration depicting the operation of the chronograph timepiece according to this embodiment of the invention;

FIG. 4 is a timing chart illustrative of the operation of the chronograph timepiece according to this embodiment of the invention;

FIG. 5 is a timing chart illustrative of the operation of the chronograph timepiece according to this embodiment of the invention; and

FIG. 6 shows a flow chart depicting the chronograph timepiece according to this embodiment of the invention.

### DETAILED DESCRIPTION OF THE INVENTION

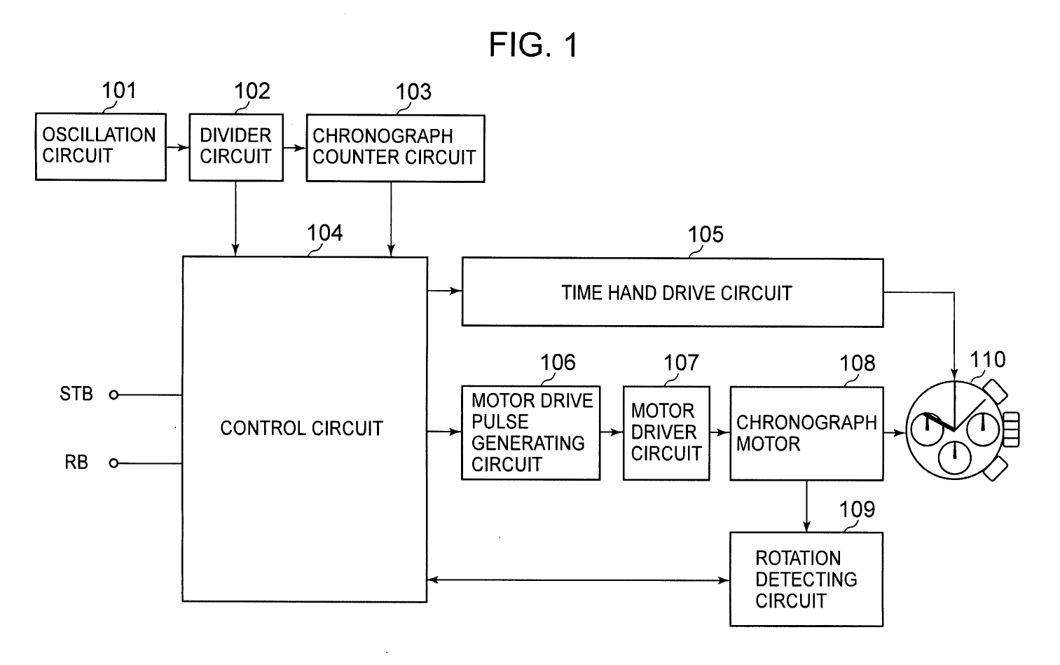

FIG. 1 is a block diagram depicting a chronograph timepiece according to an embodiment of the invention. The chronograph timepiece according to this embodiment is such a type of chronograph timepiece that chronograph hands are mechanically reset to zero and electrically driven.

In FIG. 1, the chronograph timepiece includes an oscillation circuit 101 that generates a signal at a predetermined frequency, a divider circuit 102 that divides the signal generated at the oscillation circuit 101 and generates a clock signal for timing reference, a chronograph counter circuit 103 that counts the clock signal for time measurement operations, a control circuit 104 that controls the individual electronic circuit components forming the chronograph timepiece and performs a variety of control such as drive control based on drive pulses, and a time hand drive circuit 105 that moves and drives time hands (an hour hand, minute hand, and second hand) of an analog indicating unit 110 in response to a time drive signal from the control circuit 104.

The time hand drive circuit 105 includes a circuit that drives a time motor in response to a time control signal outputted from the control circuit 104 at a predetermined time drive cycle based on the clock signal timed by the control circuit 104, the time motor that drives the time hands of the analog indicating unit 110, and a rotation detecting circuit 109 that detects the rotation status of the time motor in a predetermined period for detecting rotation.

The control circuit 104 is connected with a start/stop button STB that directs the start and stop of a time measurement (chronograph) operation, and a reset button RB that resets the time measurement operation. A start signal and a stop signal are inputted to the control circuit 104 by operating the start/stop button STB for starting or stopping, respectively, whereas a reset signal is inputted to the control circuit 104 by operating the reset button RB.

The control circuit 104 has a function of performing prescribed control by determining whether a chronograph motor 108 is rotated based on a detection signal from the rotation detecting circuit 109. It also has the following functions of controlling the individual electronic circuit components by: (i) starting a time measurement operation in response to a start signal associated with a start directed by the start/stop button STB to show a measured time period on the analog indicating unit 110; (ii) stopping the time measurement operation in response to a stop signal associated with a stop directed by the start/stop button STB; (iii) resetting a time measurement counter (not shown) provided for the control circuit 104 in response to a reset signal associated with a reset directed by the reset button RB; and (iv) stopping the time measurement operation due to the stopped chronograph motor 108.

Further, the control circuit 104 has functions of: (i) keeping time based on the clock signal from the divider circuit 102 to output the time control signal at a predetermined drive cycle for the time motor; and (ii) outputting a chronograph control signal for driving the chronograph motor 108 to a motor drive pulse generating circuit 106, every time when the chronograph counter circuit 103 keeps time for a predetermined time period (a drive cycle for the chronograph motor 108).

Furthermore, the chronograph timepiece includes the motor drive pulse generating circuit 106 that generates a chronograph drive pulse for driving the chronograph motor 108 in response to the chronograph control signal inputted from the control circuit 104 in a predetermined cycle, a motor driver circuit 107 that drives the chronograph motor 108 in response to the chronograph drive pulse, the chronograph motor 108 that moves and drives the chronograph hands (an hour hand, minute hand, and second hand) of the analog indicating unit 110, and the rotation detecting circuit 109 that detects the rotation status of the chronograph motor 108. The motor driver circuit 107 and the rotation detecting circuit 109 are circuits similar to publicly-known circuits for use in driving and detecting the rotation of stepping motors in analog electronic clocks.

The chronograph motor 108 is a stepping motor for use in typical electronic clocks. This stepping motor is such a type that includes a stator having a rotor accommodating through hole therein, a rotor rotatably disposed at the rotor accommodating through hole, and a drive coil wound on a magnetic core joined to the stator, in which drive pulses having different polarities are alternately supplied to a first terminal and a second terminal of the drive coil for rotating and driving the stepping motor at each predetermined angle.

Here, the oscillation circuit 101 and the divider circuit 102 constitute a signal generating unit, the rotation detecting circuit 109 constitutes a rotation detecting unit, the analog indicating unit 110 constitutes an indicating unit, and the start/stop button STB and the reset button RB constitute an operating unit. The motor drive pulse generating circuit 106 and the motor driver circuit 107 constitute a drive unit. Also, the oscillation circuit 101, divider circuit 102, chronograph counter 103, control circuit 104, and rotation detecting circuit 109 constitute a control unit.

In addition, as discussed above, the chronograph timepiece according to this embodiment of the invention is such a type of chronograph timepiece that chronograph hands are mechanically reset to zero and electrically driven, and the detailed explanation of mechanical devices thereof is omitted because these mechanisms are publicly known.

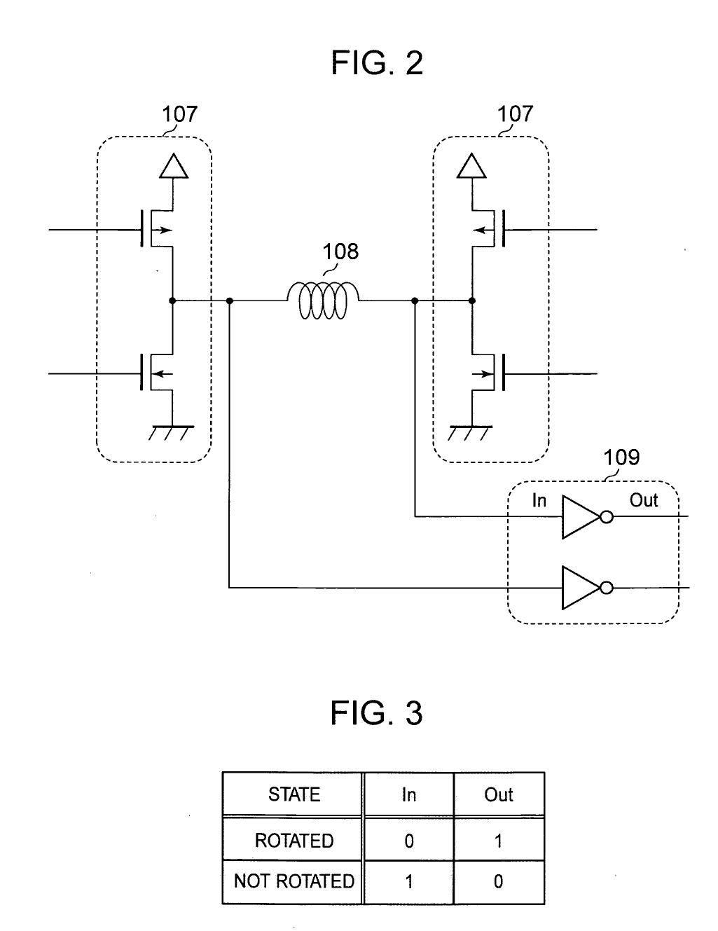

FIG. 2 shows a detailed diagram partially depicting the configurations of the motor driver circuit 107 and the rotation detecting circuit 109. In FIG. 2, the chronograph motor (a drive coil is depicted in the drawing) 108 is connected to four transistors provided on the output stage of the motor driver circuit 107.

Further, the chronograph motor 108 is connected to the rotation detecting circuit 109 having two inverters. Each two of four transistors of the motor driver circuit 107 are driven alternately crosswise in the on-state in a predetermined drive cycle, thereby switching the drive current to be supplied to the chronograph motor 108 between the forward and reverse directions to rotate and drive the chronograph motor 108 in one direction at each predetermined angle.

The rotation detecting circuit 109 amplifies an induced signal VRs generated at the chronograph motor 108 with a switching circuit, not shown, detects the induced signal VRs with the inverters, and outputs a rotation detecting signal indicating the rotation status from the inverters. Although the inverters are used in this embodiment for simplifying the configuration, a comparator may be used.

FIG. 3 is an illustration depicting the rotation detecting signals outputted from the rotation detecting circuit 109. When the level of the induced signal inputted to the inverter of the rotation detecting circuit 109 is at the low level, “0”, (the level below a predetermined reference voltage (for example, a half of power supply voltage) Vcomp), the rotation detecting signal outputted from the inverter is the high level, “1”, whereas when the level of the induced signal inputted to the inverter is at the high level, “1” (the level exceeding the predetermined reference voltage Vcomp), the rotation detecting signal outputted from the rotation detecting circuit 109 is the low level, “0”. The control circuit 104 determines that the chronograph motor 108 has been rotated when the rotation detecting signal from the rotation detecting circuit 109 is at the high level, “1”, whereas it determines that the chronograph motor 108 has not been rotated when the rotation detecting signal from the rotation detecting circuit 109 is at the low level, “0”.

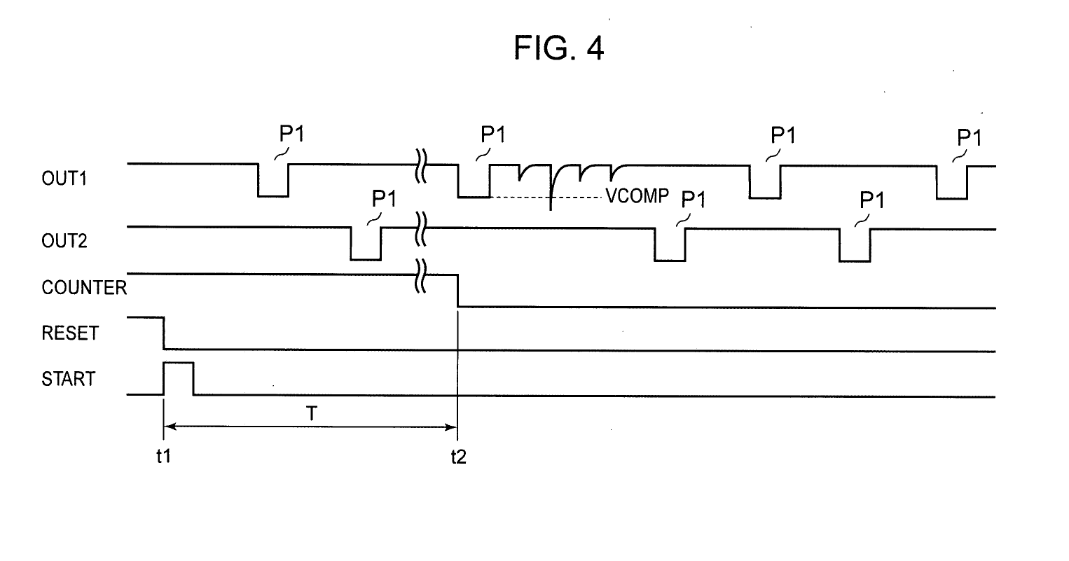

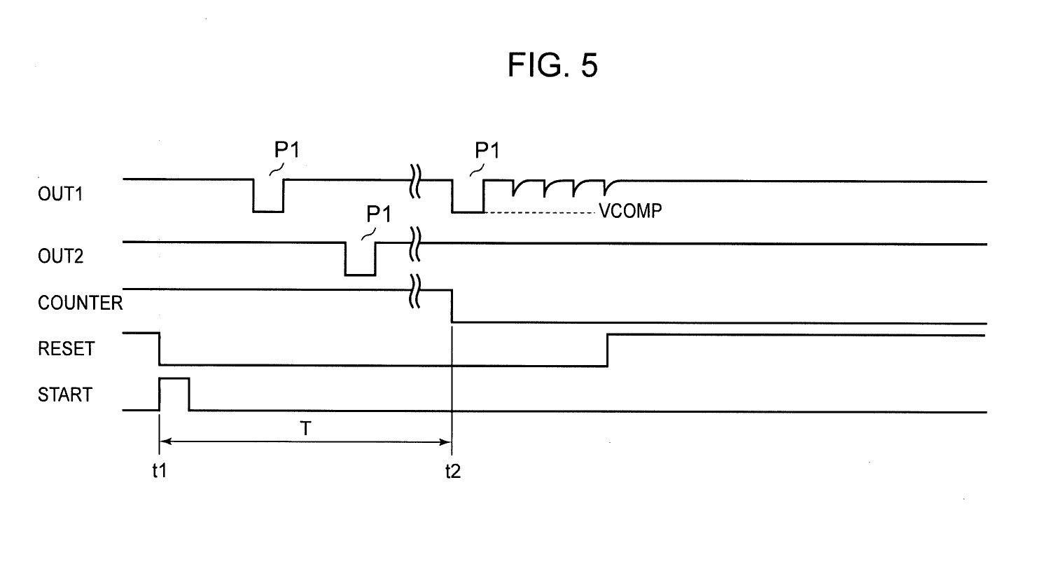

FIGS. 4 and 5 are timing charts illustrative of the operation of the chronograph timepiece according to the embodiment of the invention. FIG. 4 is a timing chart when a time measurement has been successfully started. FIG. 5 is a timing chart when noise has caused a misoperation.

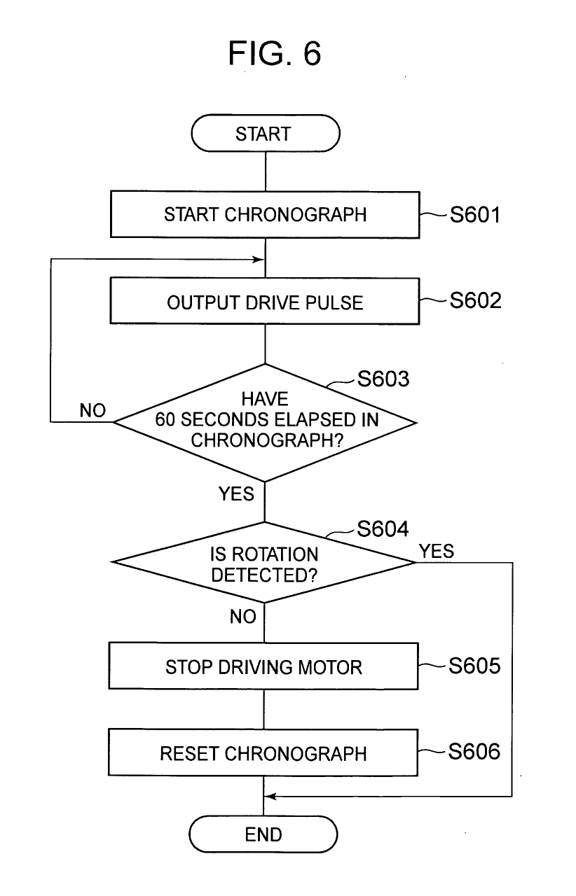

FIG. 6 shows a flow chart for the chronograph timepiece according to this embodiment of the invention.

In the following, the operation of the chronograph timepiece according to this embodiment will be described with reference to FIGS. 1 to 6.

In FIG. 1, the oscillation circuit 101 generates a signal at a predetermined frequency. The divider circuit 102 divides the signal generated at the oscillation circuit 101 and generates a clock signal to be timing reference to output the signal to the chronograph counter circuit 103 and the control circuit 104.

The control circuit 104 controls the time hand drive circuit 105 so as to move and drive the time hands of the analog indicating unit 110 by counting the clock signal for the timing operation and outputting the time control signal every time when keeping time for a predetermined time period. The time hand drive circuit 105 moves and drives the time hands of the analog indicating unit 110 in response to the time control signal from the control circuit 104 for indicating the current time.

Next, the outline of the time measurement operation will be described.

When a user operates the start/stop button STB to start a time measurement operation, a mechanical device, not shown, releases the set chronograph hands in response to the start directed by the start/stop button STB. Then, in response to the starting operation, the control circuit 104 controls the chronograph counter circuit 103 to start the time measurement operation based on the clock signal from the divider circuit 102.

The control circuit 104 controls the motor drive pulse generating circuit 106 so as to drive the chronograph motor 108 based on alternate main drive pulses P1 having different polarities by outputting the chronograph control signal every time when the chronograph counter circuit 103 keeps time for a predetermined time period.

The motor drive pulse generating circuit 106 drives and controls the chronograph motor 108 based on the alternate main drive pulses 21 having different polarities, through the motor driver circuit 107. The chronograph motor 108 moves and drives the chronograph hands of the analog indicating unit 110 for indicating a measured time period.

When the user operates the start/stop button STB to stop the time measurement operation during the time measurement operation, the control circuit 104 stops the time measurement operation in response to this stop, and a time measurement result at that point in time is indicated at the analog indicating unit 110.

Further, when the user operates the reset button RB for reset during the time measurement operation, the control circuit 104 resets the counted value of the chronograph counter circuit 103 to zero in response to this reset as well as stops the time measurement operation by stopping driving the chronograph motor 108. Then, the mechanical device resets the chronograph hands to zero in response to the reset directed by the reset button RB.

Now, there is such an event that external noise or the like can cause a state equivalent to that in which the start signal is inputted to start the time measurement operation with no operation of the start/stop button STB. This causes the chronograph motor 108 to be rotated and driven for consuming unnecessary electric power.

In this case, the chronograph motor 108 is not rotated because the mechanical device sets the chronograph hands. However, because a wheel train that transmits the rotation of the chronograph motor 108 to the chronograph hands has a backlash, such behavior is observed that the chronograph motor 108 seems to be normally rotated by an amount necessary to eliminate the backlash.

In the embodiment, it is determined whether a normal time measurement operation is being performed or noise or the like has caused an abnormal time measurement operation in order to perform proper control.

In the following, operations will be described when a normal time measurement operation is performed whereas when an abnormal time measurement operation is performed.

When the user operates the start/stop button STB to start a time measurement operation at time t1 shown in FIG. 4, a start signal START is inputted to the control circuit 104 (Step S601 shown in FIG. 6), and the mechanical device, not shown, clears the set chronograph hands in response to the start directed by the start/stop button STB. Then, the control circuit 104 controls the chronograph counter circuit 103 so as to perform the time measurement operation based on the clock signal from the divider circuit 102.

The control circuit 104 controls the motor drive pulse generating circuit 106 so as to drive the chronograph motor 108 based on the alternate main drive pulses P1 having different polarities by outputting a chronograph control signal every time when the chronograph counter circuit 103 keeps time for a predetermined time period (Step S602).

The motor drive pulse generating circuit 106 drives the chronograph motor 108 based on the alternate main drive pulses P1 having different polarities through the motor driver circuit 107, in response to the chronograph control signal. The chronograph hands of the analog indicating unit 110 are moved and driven by the chronograph motor 108, and a measured time period at that point in time is indicated at any time.

At time t2 at which the chronograph counter circuit 103 has counted for a predetermined time period T (in the embodiment, 60 seconds) from the start of time measurement (Step S603), the control circuit 104 controls the rotation detecting circuit 109 so as to detect the rotation status of the chronograph motor 108 due to the drive based on the main drive pulses P1. The rotation detecting circuit 109 amplifies the induced signal VRs generated at the chronograph motor 108 with a switching circuit, not shown, and outputs a rotation detecting signal at the high level, “1”, or the low level, “0”, which indicates the rotation status based on the induced signal VRs.

The control circuit 104 determines that the chronograph motor 108 has been rotated when the rotation detecting signal from the rotation detecting circuit 109 is at the high level, whereas it determines that the chronograph motor 108 has not been rotated when the rotation detecting signal from the rotation detecting circuit 109 is at the low level (Step S604).

When the control circuit 104 determines that the chronograph motor 108 is being rotated based on the rotation detecting signal from the rotation detecting circuit 109, it determines that the starting operation has been normally performed. As shown in FIG. 4, it then continues drive based on the main drive pulses P1, and continues the time measurement operation.

On the other hand, when the control circuit 104 determines that the chronograph motor 108 is not being rotated based on the rotation detecting signal from the rotation detecting circuit 109 (this case is the case in which the chronograph motor 108 has been rotated because a signal equivalent to the start signal was inputted due to noise or the like, and the control circuit 104 determines that the chronograph motor 108 has been temporarily rotated but the chronograph motor 108 is locked at the current point in time), as shown in FIG. 5, it stops driving the chronograph motor 108 (Step S605), and generates a reset signal to reset the counted value of the chronograph counter circuit 103 (Step S606).

Accordingly, when it is determined that the chronograph motor 108 is being locked after the chronograph motor 108 is driven, it is made possible to stop the wrongly operated time measurement operation, and it is made possible to eliminate unnecessary power consumption.

Also, for the rotation detecting operation, it is enough to detect binary states in which the chronograph motor 108 has been rotated, or locked and not completely rotated. Consequently, it is unnecessary to use a comparator of high detection accuracy, and it is unnecessary to set a precise reference voltage Vcomp for distinguishing between rotation and non-rotation. Accordingly, because it is unnecessary to strictly adjust a threshold for detecting rotation and a rough threshold will do, an advantage of a simple configuration is also exerted since inverters can be used to facilitate detection.

In addition, in this embodiment, it is configured that when the rotation status of the chronograph motor 108 is detected after the predetermined time period T has elapsed from the starting operation for time measurement, this predetermined time period T is timed by the chronograph counter circuit 103. However, such a configuration may be formed that the rotation status of the chronograph motor 108 is detected after drive based on the main drive pulses is performed at a predetermined number of times.

In other words, such a configuration may be formed that the control circuit 104 determines that the chronograph motor 108 has been driven for the predetermined time period T when the chronograph motor 108 is driven for a predetermined number of times based on the main drive pulses.

In this case, because the chronograph timepiece has the wheel train that transmits the rotation of the chronograph motor 108 to the chronograph hands, the above-mentioned predetermined number of times may be set to the number of times for eliminating the wheel train backlash.

The invention is applicable to various chronograph timepieces that motors electrically drive time hands and chronograph hands, a mechanical device sets the chronograph hands in the reset state, and the chronograph hands are driven after the setting by the mechanical device is cleared.

What is claimed is:

1. A chronograph timepiece that is mechanically reset to zero, comprising:
a chronograph motor configured to drive a chronograph hand;
a drive unit configured to drive the chronograph motor according to a time measurement operation in response to a starting operation by an operating unit; and
a control unit configured to control the drive unit, wherein
the control unit includes a rotation detecting unit for detecting a rotation status of the chronograph motor, wherein when the rotation detecting unit detects that the chronograph motor is not rotated after the chronograph motor has been driven for a predetermined time period, driving the chronograph motor by the drive unit is stopped for resetting the time measurement operation.

2. A chronograph timepiece according to claim 1, wherein
the control unit includes a chronograph counter for counting a measured time period, and the control unit measures the predetermined time period using the chronograph counter.

3. A chronograph timepiece according to claim 1, wherein
the control unit determines that the chronograph motor has been driven for the predetermined time period, when the chronograph motor is driven for a predetermined number of times based on a drive pulse.

4. A chronograph timepiece according to claim 3, further comprising a wheel train for transmitting the rotation of the chronograph motor to the chronograph hand, and the predetermined number of times is a number of times for eliminating a backlash of the wheel train.

5. A chronograph timepiece according to claim 1, wherein
the rotation detecting unit has an inverter for detecting whether an induced signal of the chronograph motor exceeds a predetermined level, and the rotation detecting unit detects the rotation status based on an output signal from the inverter.

6. A chronograph timepiece according to claim 2, wherein
the rotation detecting unit has an inverter for detecting whether an induced signal of the chronograph motor exceeds a predetermined level, and the rotation detecting unit detects the rotation status based on an output signal from the inverter.

7. A chronograph timepiece according to claim 3, wherein
the rotation detecting unit has an inverter for detecting whether an induced signal of the chronograph motor exceeds a predetermined level, and the rotation detecting unit detects the rotation status based on an output signal from the inverter.

8. A chronograph timepiece according to claim 4, wherein
the rotation detecting unit has an inverter for detecting whether an induced signal of the chronograph motor exceeds a predetermined level, and the rotation detecting unit detects the rotation status based on an output signal from the inverter.
